(19) United States
(12) Patent Application Publication
(10) Pub. No.: US 2004/0104506 A1
(43) Pub. Date: Jun. 3, 2004

(54) ROBOTIC METHOD AND APPARATUS FOR REMOVING PARTS FROM THE TRIM PRESS OF A THERMOFORMING SYSTEM

(75) Inventors: Thomas Schelmbauer, Hyannis, MA (US); Jeff Feehan, Plymouth, MA (US)

Correspondence Address: BLACKWELL SANDERS PEPER MARTIN LLP, 720 OLIVE STREET, SUITE 2400, ST. LOUIS, MO, 63101, US

(73) Assignee: SENCORP SYSTEMS, INC., Hyannis, MA (US)

(21) Appl. No.: 10/605,856

(22) Filed: Oct. 31, 2003

Related U.S. Application Data
(60) Provisional application No. 60/319,663, filed on Nov. 1, 2002.

(51) Int. Cl. B28B 7/14; B28B 13/06

(52) U.S. Cl. 264/163; 264/335; 425/444; 425/406; 425/290

(57) ABSTRACT

A robotic method and apparatus for removing finished parts from the trim press of a thermoforming system including a pick and place tool mechanism moveable on at least a two-axis gantry mechanism arranged adjacent the trim press, the pick and place tool being moveable into and out of the trim press to acquire and remove finished thermoformed parts from the trim press. Movement of the pick and place tool is synchronized with the trim press cycle. The present method may include a conveyance system mounted adjacent the pick and place mechanism for placing and stacking the finished thermoformed parts thereon once such parts are removed from the trim press.

### CROSS REFERENCE TO RELATED APPLICATIONS

This application claims the benefit of U.S. Provisional Application Serial No. 60/319,663 filed Nov. 1, 2002.

### BACKGROUND OF INVENTION

A wide variety of plastic articles may be made using a thermoforming method and system. A typical thermoforming system performs a series of operations on a thermoplastic sheet of material. These operations include sheet feed/unwind, heating, forming, trimming, and stacking. The feed/unwind station of a typical thermoformer machine provides the sheet of material to the machine. This can be accomplished by either unwinding a roll of thermoplastic material as illustrated in FIG. 1 or by feeding any plurality of sheets of material into the machine. Once the material enters the machine, the sheet of material then travels to a heating station where it is heated to its glass transition phase. The heated material is then moved into a forming station where it undergoes a forming operation. During the forming operation, the heated thermoplastic material is formed into specific shapes using a vacuum and/or pressure system employing upper and lower moving press platens and a precision shaped tool. The end result of this process is an array of molded articles in the sheet material. This array of formed articles or parts are then indexed to a trimming station where a punch and die arrangement is employed to remove the surrounding support area from around the thermoformed articles. The thermoforming system may optionally include a part recovery station to recover the molded articles, and a scrap winding station to remove all of the waste material from the machine.

A typical trim station cuts the thermoformed array free from the web of material with the exception of a few small areas known in the art as “nicks”. These “nicks” hold the various parts in the sheet for transportation out of the trim press and to a stacker station that breaks these molded parts free from the web and presents them in stacks for removal. There are two common methods employed by stackers, namely, up-stacking and down stacking. Up-stacking is accomplished using a vertically driven tool that cycles up and down freeing the molded parts from the web of material and stacking them above the web in the process. Up-stacking as a method is simplistic and intuitive, yet it does pose serious problems with ergonomics, long tool change-over times, and expensive tooling necessary to handle different applications. Down-stacking employs a similar motion, only inverted such that the molded parts are pushed downward through the web from above. Down-stacking has the same issues as up-stacking regarding tool changeover times and tool cost, but it helps to resolve the ergonomic issues that make up-stacking undesirable.

Another common problem when dealing with standard stacking practices are the aforementioned “nicks”. The “nicks” that are used for material transport from the trim station to the stacker station remain as sharp points on the perimeter of the molded parts after the parts are removed from the sheet. “Nicks” are undesirable for certain industries that require parts with clean surfaces because they have the possibility of catching or snagging other articles that they may come in contact with.

To deal with these multiple issues of part removal it is necessary to look at new methods of part removal from thermoformers, more particularly, to remove molded parts with a nick-less trim, stack them, and present them at an ergonomic level for the operators' removal.

### SUMMARY OF INVENTION

The present invention relates to a new method for part removal in a thermoforming system addressing ergonomics, nick-less part trimming, and quick-change tools. The invention is directed to a two-axis gantry mechanism that is arranged such that a quick-disconnect end effector or pick and place arm mechanism enters an opened trim press. The molded parts are then acquired, removed from the trim press, and placed at an ergonomic level for an operator to remove from the machine.

The present invention is coupled with a trim press equipped with a cutting tool that completely frees the molded parts from the web of material without forming “nicks” on the perimeter. The cutting tool includes knives that may be in the upper or lower portion of the tool with the opposite side of the tool set being the anvil. For use in the present invention, one of the trim press tool halves is equipped with orifices for vacuum. These vacuum orifices make it possible for the trim press tool to acquire the parts and maintain their positions accurately within the press from the instant they are cut free from the web, through the opening of the trim press, and retraction of the lower trim tool. This provides clearance for the pick and place tool to enter the trim press.

The present invention includes a frame that is fixed to and carried by the trim press. This support structure bolsters the weight of the entire mechanism and also supplies a rigid connection that follows the motion of the trim press when it is adjusted, thus maintaining a constant relationship between the lower trim press platen and the mount for the end effector or the pick and place tool. The pick and place tool is animated using a modified gantry setup designed to deliver two-axis movement that, in the embodiment illustrated, takes place beneath the web-line or the path of the sheet material as it continues through the machine during the thermoforming process. The drive system for the pick and place tool is fully controllable and includes a mechanism using horizontal actuation that supports and drives the structure responsible for the vertical movement. The vertical actuation system carries a manufactured brace that provides a mounting surface for a pneumatically actuated robotic quick-change mechanism. This mechanism holds the pick and place tool rigidly and accurately to the mounting surface and provides quick disconnect ports to supply the tool with vacuum and air. The pick and place tool construction will vary based upon individual applications, but typically this tool will have appropriate vacuum runs that coincide with the number of different vacuum zones necessary to stack the molded parts in the desired arrangement, as well as vacuum cups or other appropriate part acquisition devices that are positioned and located based upon the part geometry and the various pick points for each respective part. Multiple vacuum zones allow what is known in the industry as “A-B” stacking.

Mounted adjacent to the pick and place mechanism is a conveyance system. This system provides an area for the pick and place tool to stack the finished thermoformed parts and then transport them to an operator pack off area at an ergonomic level when a predetermined stack count is complete.

To accomplish the pick and place process of the present invention, it is necessary to maintain proper synchronization with the trim press cycle. After the trim press opens and the lower trim tool retracts, the pick and place tool mechanism moves horizontally into the trim press, settling into a position matching that of the array of part acquisition devices (i.e. vacuum cups) and the array of pick points associated with a given lot of molded parts. A short vertical move is then queued to initiate contact between the thermoformed parts and the pick and place tool thus allowing the part acquisition devices to capture and hold the finished parts. The vertical movement and the original press entry movement of the pick and place tool are then retracted. As the trim press closes, the pick and place tool mechanism strokes vertically to the conveyance system surface where it releases the molded parts before retracting and starting the cycle over. This vertical movement to the conveyance system surface becomes incrementally smaller each cycle to create a stack of finished parts, until a predetermined stack height is reached and the conveyance system clears the stacking surface.

### BRIEF DESCRIPTION OF DRAWINGS

FIG. 1 is a schematic illustration of a conventional thermoforming process.

FIG. 2 is a side elevational view of a trim press associated with a thermoforming process constructed according to the teachings of the present invention.

FIG. 3 is a partial cut-away top plan form view of the robotic mechanism associated with the trim press of FIG. 2 for removing finished parts therefrom.

FIG. 4 is a partial rear elevational view of the robotic mechanism of FIG. 2.

FIG. 5 is an enlarged partial cut-away side elevational view of the trim press of FIG. 2 showing the relative position and motion of the upper and lower trim press platens and the pick and place tool of the present invention.

FIG. 6 is an enlarged partial cut-away rear elevational view similar to FIG. 5 showing the pick and place tool of the present invention positioned between the upper and lower trim press platens.

FIG. 7 is a top planform view of one embodiment of a pick and place tool constructed in accordance with the teachings of the present invention.

FIG. 8 is a front elevational view of the pick and place tool illustrated in FIG. 7.

FIG. 9 is a side elevational view of one embodiment of a conveyance system constructed in accordance with the teachings of the present invention.

### DETAILED DESCRIPTION

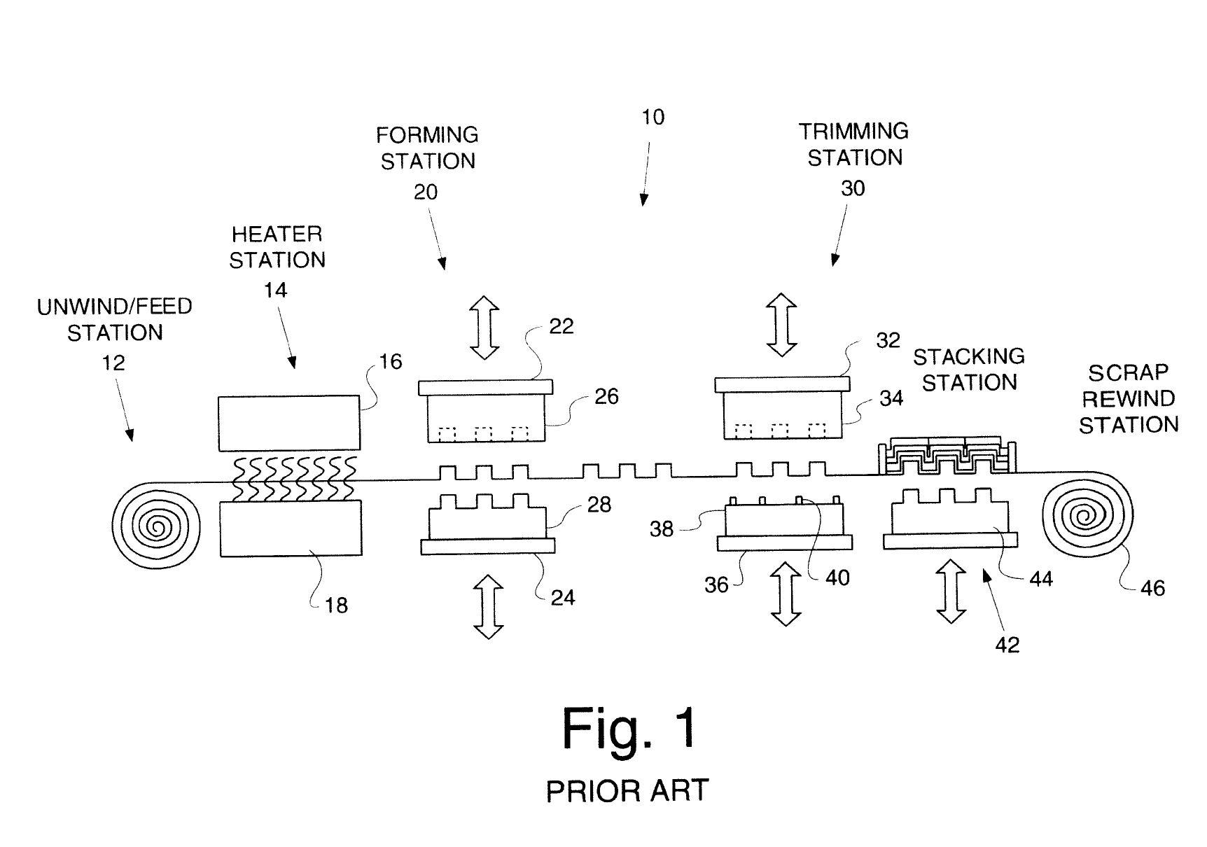

Referring to the drawings more particularly by reference numbers wherein like numerals refer to like parts, number 10 in FIG. 1 identifies a typical thermoforming process and system commonly used in a wide variety of different industries to make a wide variety of different plastic products. As illustrated in FIG. 1, a typical thermoforming system includes a material unwind station 12 wherein a roll of thermoplastic sheet material is fed into a heater station 14 where the sheet of material is heated to its glass transition phase. The heater station 14 typically includes upper and lower heaters 16 and 18 which may be independently retractable for maintenance and tool set up accessibility. Once the sheet or web of material is properly heated, it moves into a forming press 20 where the heated sheet of material is formed into the specific shapes of the products or parts being manufactured using a vacuum/pressure system. The forming press 20 typically includes upper and lower press platens 22 and 24 each having a precision shaped tool 26 and 28 associated respectively therewith. The press platens 22 and 24 independently move relative to each other between an open position and a closed position. In its closed position, the press tools 26 and 28 engage the heated sheet material and form an array of molded products within the sheet material. These formed molded products remain unitary with the sheet material and thereafter move into trimming press 30. Any number or plurality of products or parts can be formed with each cycle of the forming press 20. Movement of the forming press platens 22 and 24 can be accomplished hydraulically, pneumatically, electrically through the use of servomotors, or through any combinations thereof or still other known means. In a particular embodiment, forming is accomplished through a heavy-duty four-post, four-point toggle operated press and the return strokes of the platens 22 and 24 can be independently controlled by adjustable stops and decelerating valves. A crank or gear motor will typically locate the press in the index direction.

Trimming press 30 likewise includes an upper trim press platen 32 having a tool 34 associated therewith and a lower trim press platen 36 having a tool 38 associated therewith. The trim press 30 functions as a punch and die press to remove the surrounding support area from around the thermoformed articles through the use of a plurality of knife blades such as the knife blades 40 illustrated in FIG. 1. The trim press is utilized for the die trimming of the formed parts or products, the top and bottom moving platens being driven either electrically, hydraulically, and/or pneumatically. In one embodiment, the top moving platen 32 may use a four-point toggle system driven by a servomotor wherein the bottom moving platen 36 uses a four-point toggle system driven hydraulically. Trim pressure can be provided by a hydraulic bump cylinder system. Manual or optional electronic controls allow adjustment of the trim press in the index direction. The return strokes of the platens 32 and 36 are typically independently controlled by adjustable stops and decelerating valves.

In a conventional thermoforming process, the trim press 30 cuts the thermoformed array of articles free from the web or sheet of material with the exception of a few small areas known as “nicks”. These “nicks” hold the array of parts to the sheet or web of material for transportation out of the trim press 30 to a stacker station 42 where the array of articles are broken free from the web or sheet of material through the use of a vertically driven platen and tool 44 that cycles up and down freeing the parts from the web and stacking them either above or below the sheet of material. An up-stacking method is illustrated in FIG. 1. Once the array of articles are separated from the web of material and stacked, the remaining web of scrap material is typically rewound at rewind station 46.

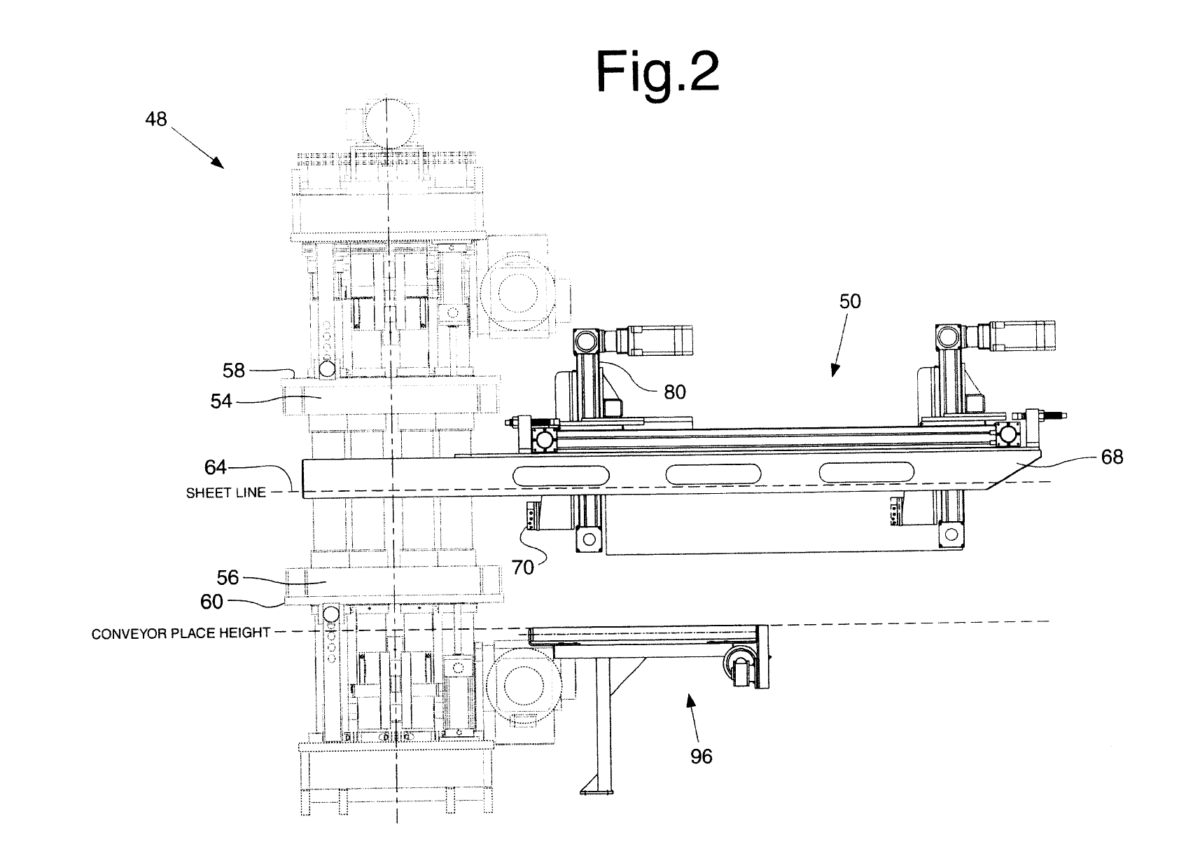

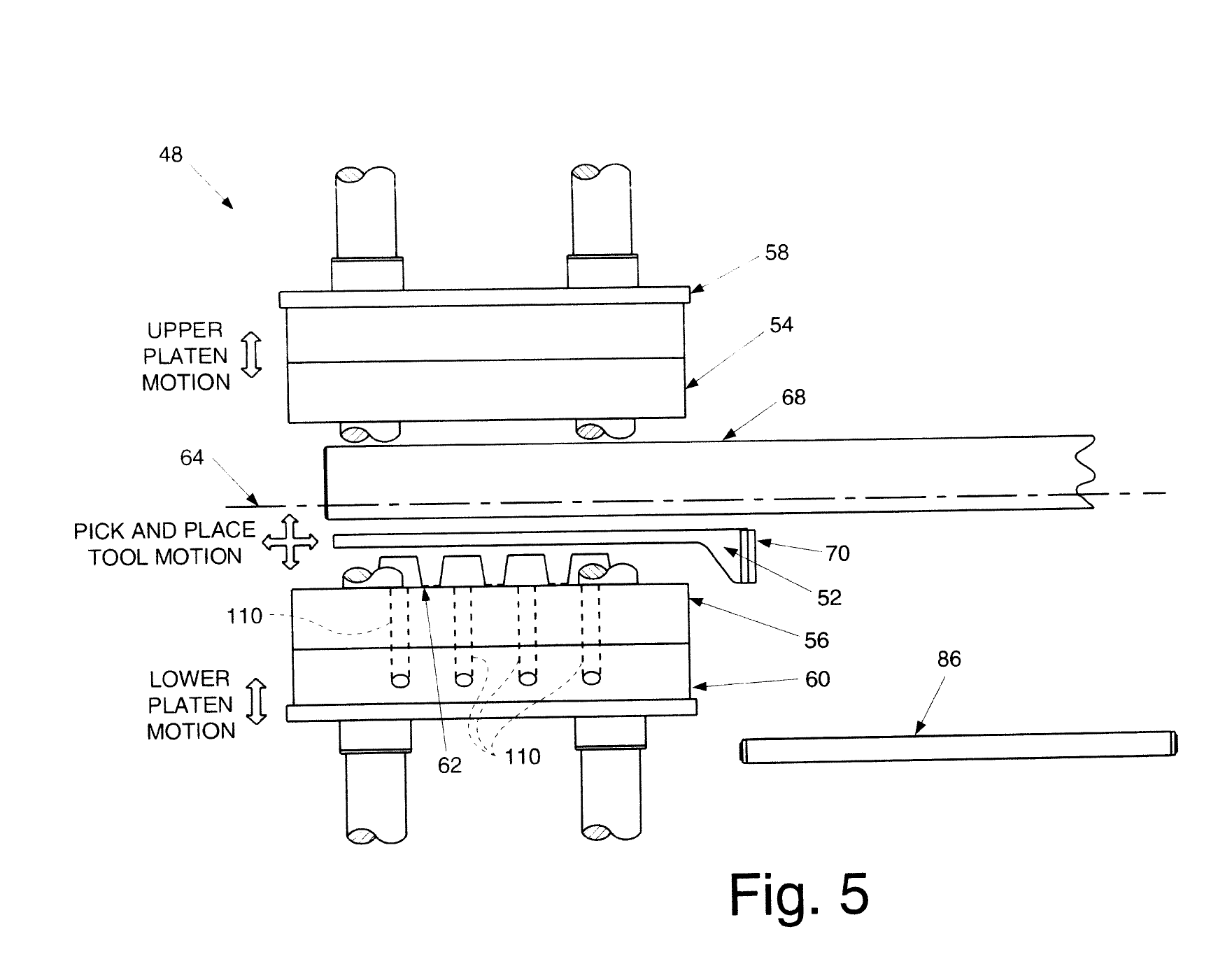

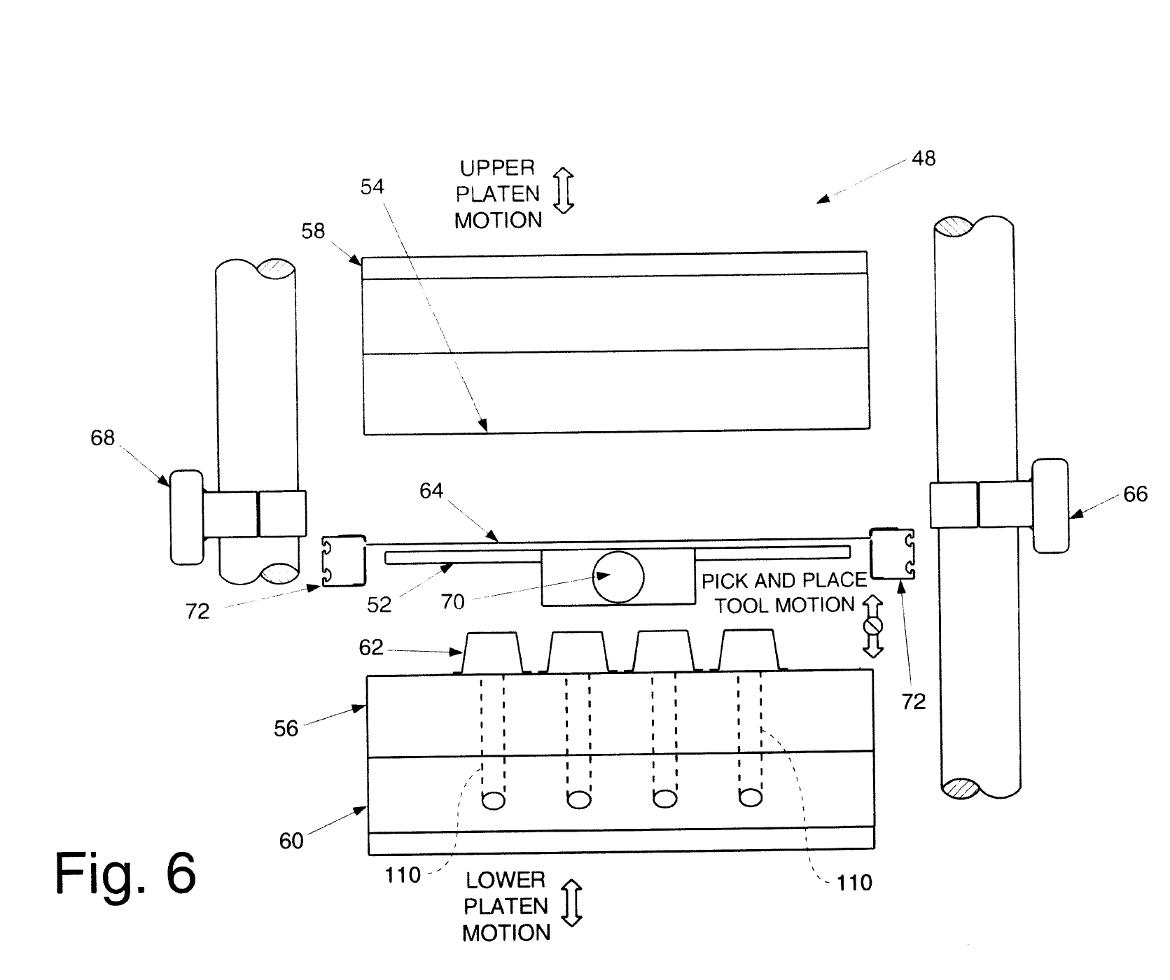

FIGS. 2-6 illustrate a trim press 48 adapted for housing the present method and apparatus for removing the thermoformed articles from the trim press. The present invention includes a two-axis gantry mechanism 50 that is positioned and arranged adjacent one end of trim press 48 such that a quick-disconnect end effector or pick and place tool 52 (FIGS. 5-8) can robotically move into and out of the opened trim press 48 to engage the separated thermoformed articles and remove the same from trim press 48. In this regard, unlike conventional trim presses, trim press 48 includes appropriate tools 54 and 56 associated respectively with the upper and lower trim press platens 58 and 60 to achieve a complete cutting or severing of the thermoformed articles 62 as best illustrated in FIGS. 2, 5 and 6. The cutting tools 54 and 56 completely free and sever the thermoformed articles 62 (FIGS. 5 and 6) from the sheet or web of material which moves along a path indicated by the line 64 in FIGS. 2-6. Appropriate knives or other cutting implements may be associated with either the upper trim tool 54 or the lower trim tool 56 to achieve the complete separation of the array of thermoformed articles. Since the trim tools 54 and 56 accomplish a complete separation of the thermoformed articles from the sheet or web of material, one of the trim tool halves, either 54 or 56, is equipped with a plurality of orifices for pulling a vacuum. These vacuum orifices make it possible for the trim press tool to hold and acquire the severed thermoform articles and maintain their respective positions accurately from the time that they are cut free from the web through the opening of the trim press 48 and retraction of the trim tools 54 and 56. In the embodiment illustrated in FIGS. 2-6, the vacuum orifices 110 (FIGS. 5 and 6) are associated with the lower trim press tool 56 and the pick and place tool 52 is positioned and located so as to enter the press 48 and maneuver to pick and place the severed thermoformed articles underneath the sheet line or path 64 of the web of material. Retraction of the trim press tools 54 and 56 to their open position after accomplishing the cutting operation provides the necessary clearance for the pick and place tool 52 to enter the trim press and maneuver therewithin to accomplish the removal of the severed thermoformed articles 62 as will be hereinafter further explained.

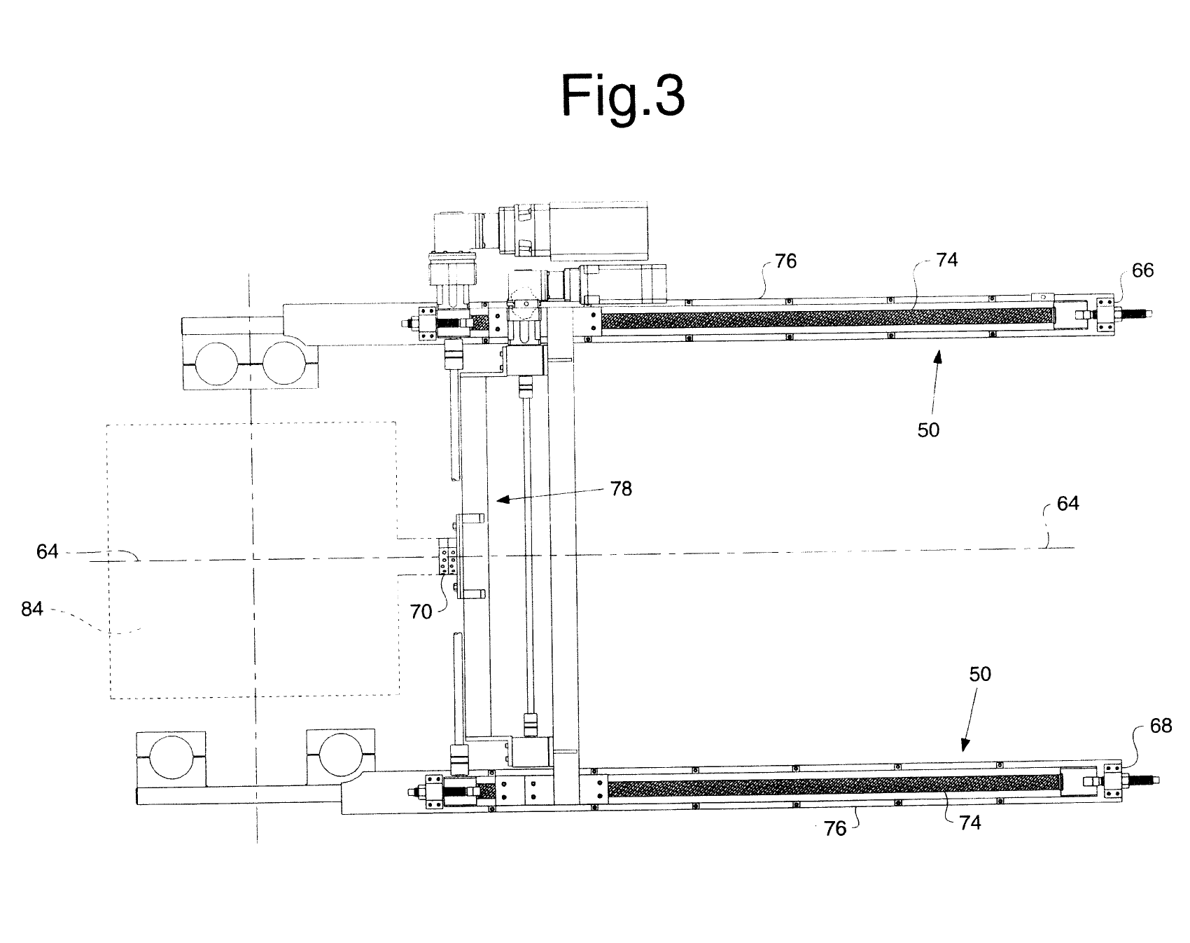

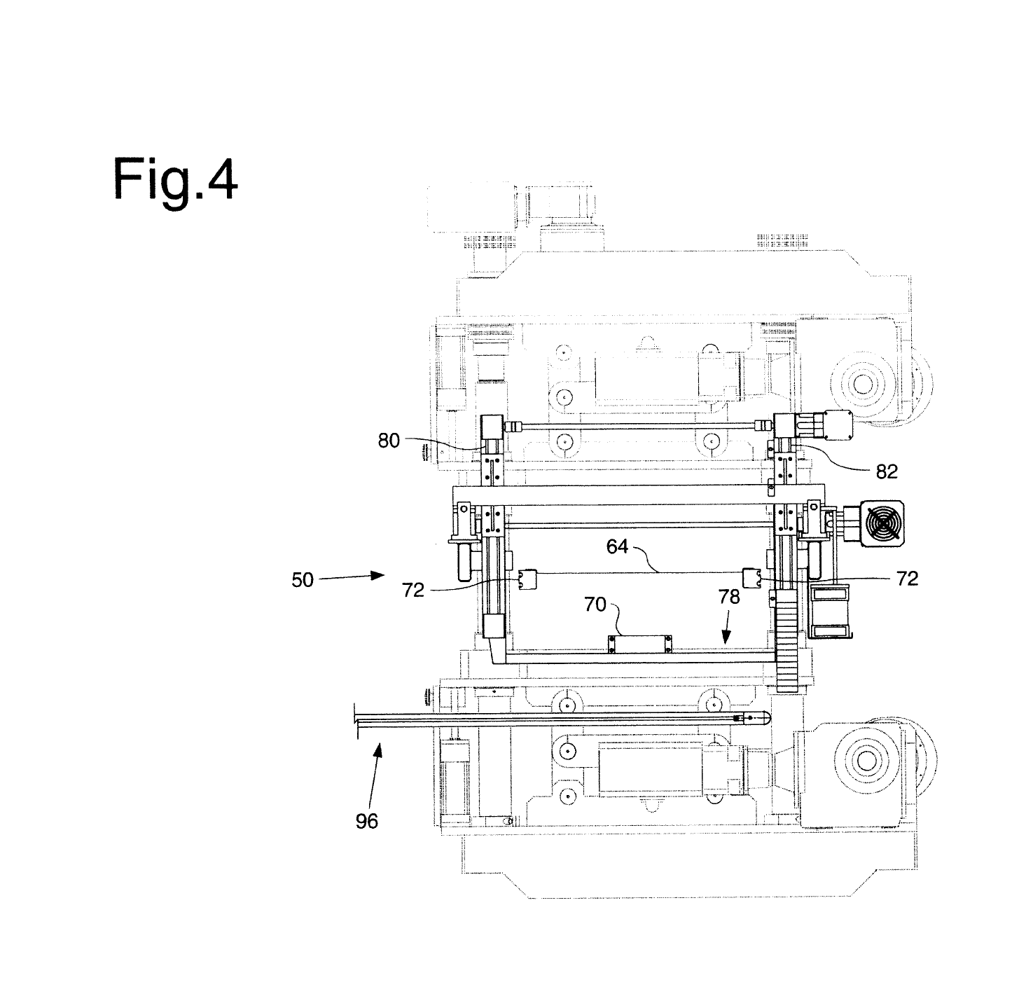

The gantry mechanism 50 includes a pair of rigid support beams 66 and 68 and other frame members which are fixed to and carried by the trim press 48 as best shown in FIGS. 2 and 3. This support structure carries the weight of the entire mechanism and also supplies a rigid connection that follows the motion of the trim press platens 54 and 56 when they are adjusted, thus maintaining a constant relationship between at least the lower trim press platen 56 and the quick-disconnect mount 70 for the pick and place tool 52. The pick and place tool 52 is moveable using a modified gantry set up designed to deliver two-axis movement that, in the embodiment shown in FIGS. 2-6, takes place beneath the path 64 of the sheet or web of material that continues through the trim press 48 during the thermoforming process. As best shown in FIGS. 4 and 6, chain rails 72 are responsible for transporting the sheet or web of material through the various stations associated with a typical thermoforming process. The chain rails 72 typically work in conjunction with a servo drive system for moving the web of material through the thermoforming process. A typical servo drive system may include an AC brushless motor with a position feedback encoder, the servo amplifier providing precision closed loop control of the index length selected. The material advance will be typically accomplished by pin chains driven by the servomotor and carried by the chain rails 72.

The drive system for moving and manipulating the pick and place tool 52 may include a belt drive system associated with each support beam 66 and 68, each support beam 66 and 68 including a belt 74 and at least one belt drive linear actuator 76 as best shown in FIG. 3. A substantially U-shaped carriage member 78 as best illustrated in FIG. 4 is coupled to the support beams 66 and 68 and their respective belt drive systems 74 and 76 for horizontal movement therealong as best seen in FIGS. 2 and 3. Vertical movement of the carriage assembly 78 is accomplished along one or more vertical support members or vertical actuators such as the vertical actuators 80 and 82 (FIG. 4) via appropriate drive mechanisms which can be electrically, hydraulically and/or pneumatically controlled.

The quick-disconnect mechanism 70 is carried on the carriage assembly 78 as best shown in FIGS. 2-4 and is designed to engage a plurality of different pick and place tools depending upon the particular application involved. The quick-disconnect mechanism 70 holds the pick and place tool 52 rigidly and accurately and provides quick-disconnect ports to supply the tool with vacuum and air. The pick and place tool construction itself will vary based upon the particular application, namely, the size and shape of the thermoformed articles being produced by the thermoforming process, but typically the pick and place tool 52 will include vacuum runs that coincide with the number of different vacuum zones necessary to pick, place and stack the thermoformed parts in a particular desired arrangement. The tool 52 will also include an appropriate number of vacuum cups or other appropriate devices that are likewise strategically positioned and located on the tool based upon part geometry and the pick points associated with each thermoformed article. The area 84 illustrated in FIG. 3 represents the area within the trim press 48 between the upper and lower platens 54 and 56 within which the pick and place tool 52 can be maneuvered to accomplish its desired task. Once the tool 52 is attached to the quick-disconnect mechanism 70, it can be moved both horizontally and vertically as illustrated in FIGS. 2-6 to engage the thermoformed articles and remove them from the trim press 48. The various drive mechanisms for accomplishing the horizontal and vertical movement of the pick and place tool 52 is fully controllable and programmable through a process controller associated with the thermoforming system.

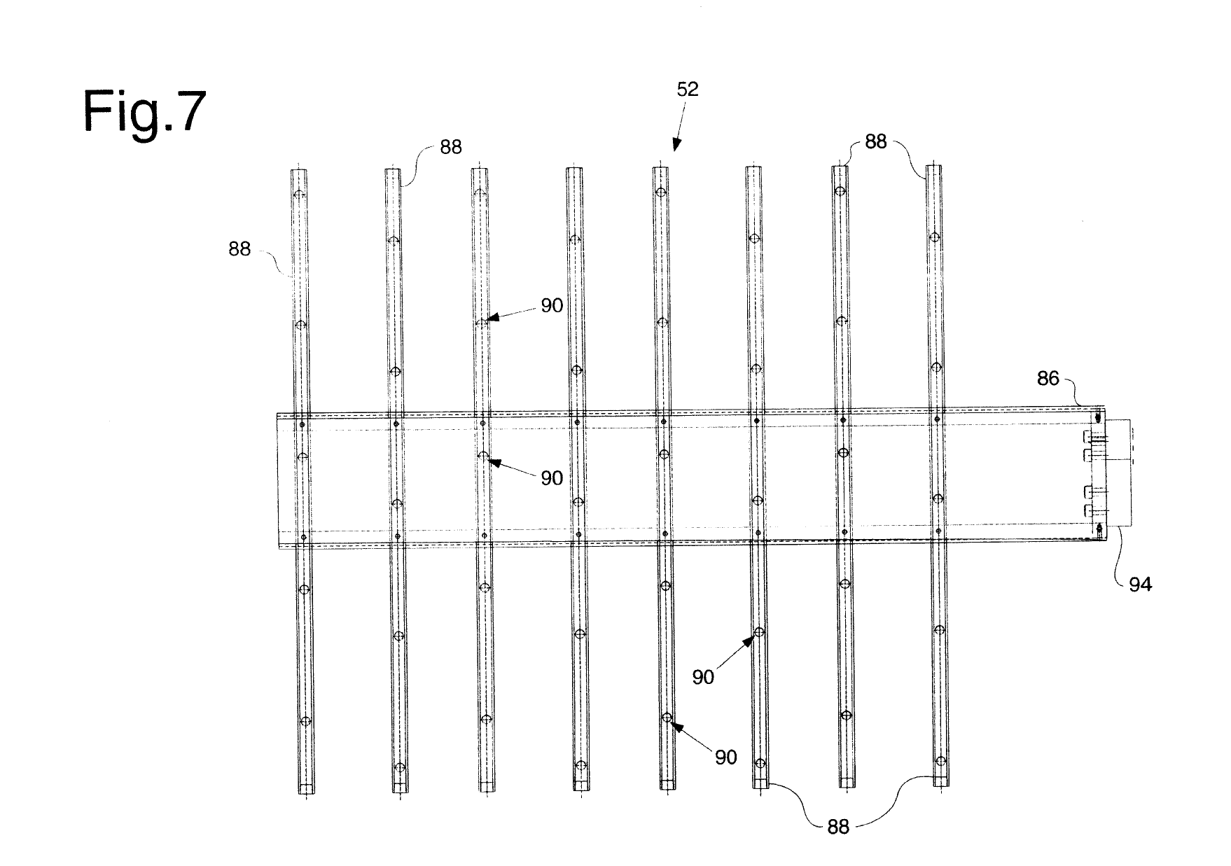

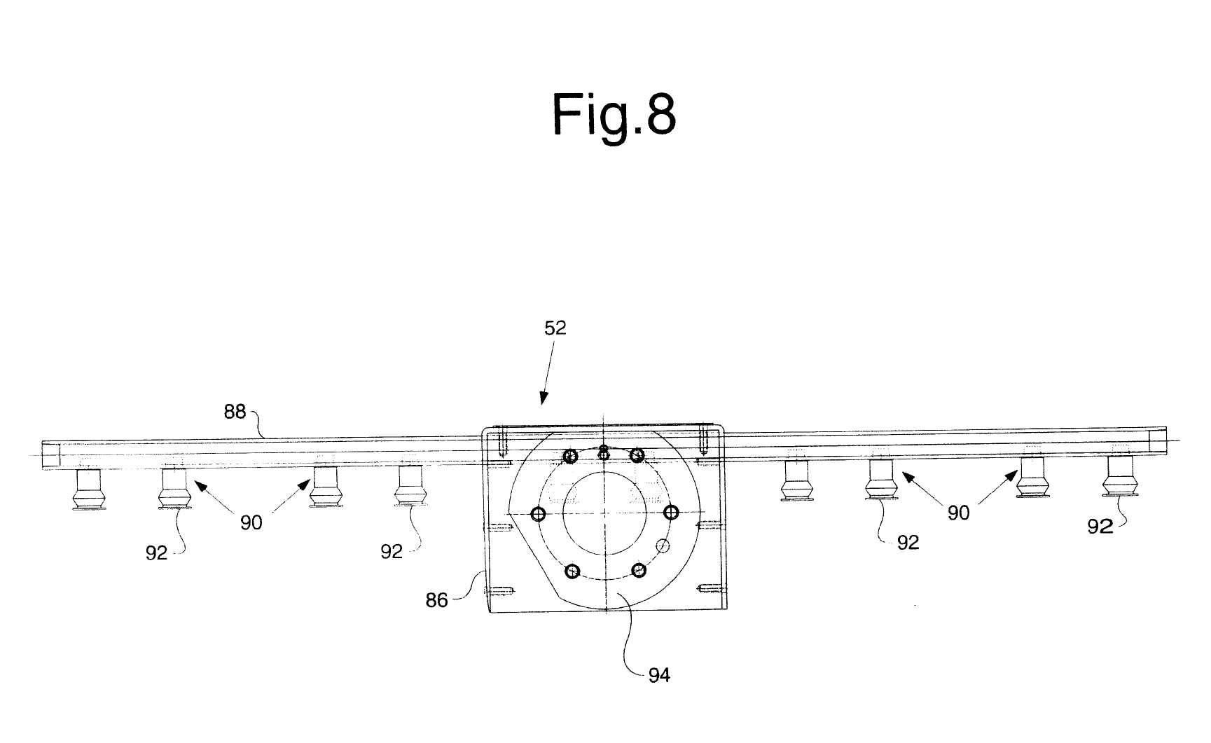

FIGS. 7 and 8 illustrate one embodiment of a pick and place tool 52 constructed in accordance with the teachings of the present invention and adaptable for engagement with the quick-disconnect mechanism 70. The pick and place tool 52 includes a main arm frame member 86 and a plurality spaced apart transverse members 88 as best illustrated in FIG. 7. Each transverse member 88 includes a plurality of spaced apart holding means or part acquisition devices such as the vacuum means 90 best illustrated in FIG. 8 for engaging and holding the thermoformed articles or parts once they are severed from the sheet of material by trim press 48 and once the pick and place tool 52 has been maneuvered adjacent the severed thermoformed articles or parts. In the embodiment illustrated in FIGS. 7 and 8, each member 88 includes appropriate conduits or plumbing within each such member for supplying air, vacuum and/or electricity to the vacuum means 90 as well as the appropriate fittings and adapter members including a vacuum cup or suction cup 92 located at the terminal end portion thereof as best illustrated in FIG. 8. In this regard, main arm frame member 86 likewise includes appropriate plumbing and connections for supplying each member 88 with air, vacuum, and/or electricity if needed as well as an appropriate mounting or coupling mechanism 94 for cooperatively engaging and coupling to the quick-disconnect mechanism 70. The holding means or vacuum means 90 associated with the pick and place tool 52 illustrated in FIGS. 7 and 8 are positioned and located so as to coincide with the position and location of the plurality of thermoformed articles associated with trim press 48 when trim press 48 severs such thermoformed articles from the web of material and moves to its open position. In the particular embodiment illustrated in FIGS. 7 and 8, the vacuum means 90 are offset or staggered from one transverse member 88 to another. The coupling or mounting mechanism 94 will likewise include appropriate fittings or other mechanisms known in the art for cooperatively engaging the vacuum, air and electrical connections associated with quick-disconnect mechanism 70.

The pick and place tool 52 illustrated in FIGS. 7 and 8 is specifically designed to overlay the area 84 illustrated in FIG. 3 so that one or more vacuum means or other pick-up mechanisms 90 will engage the plurality of thermoformed articles awaiting pick-up and removal from within the trim press 48 when the tool 52 is operatively positioned within the trim press 48. Although FIGS. 7 and 8 illustrate one embodiment of a pick and place tool 52, it is recognized and anticipated that the pick and place tool construction will vary based upon the types of articles being formed and severed during the thermoforming process as well as the size and shape of each such article or part. In addition, it is recognized and anticipated that any appropriate number of vacuum means 90 or other pick-up or holding devices associated with the pick and place tool 52 may be associated with a particular tool 52 and the various holding means or vacuum means 90 will be strategically positioned and located on the tool based upon the part geometry and the pick-up points associated with each thermoformed article. FIGS. 7 and 8 represent just one embodiment of a pick and place tool 52 constructed for a particular application and it is recognized and anticipated that a wide variety of different pick and place tools may be used in association with the present method and apparatus.

Mounted adjacent both the trim press 48 and the pick and place mechanism 50 and 52 is a conveyance system 96 as best illustrated in FIGS. 2, 4 and 5. This conveyance system can take on a wide variety of different shapes, sizes and configurations and provides a surface area for the pick and place tool 52 to stack the finished thermoformed parts 62. When a predetermined number of finished thermoformed parts are stacked, the conveyance system 96 can be programmed to transport such stacks of finished products to an operator pack off area at an ergonomic level.

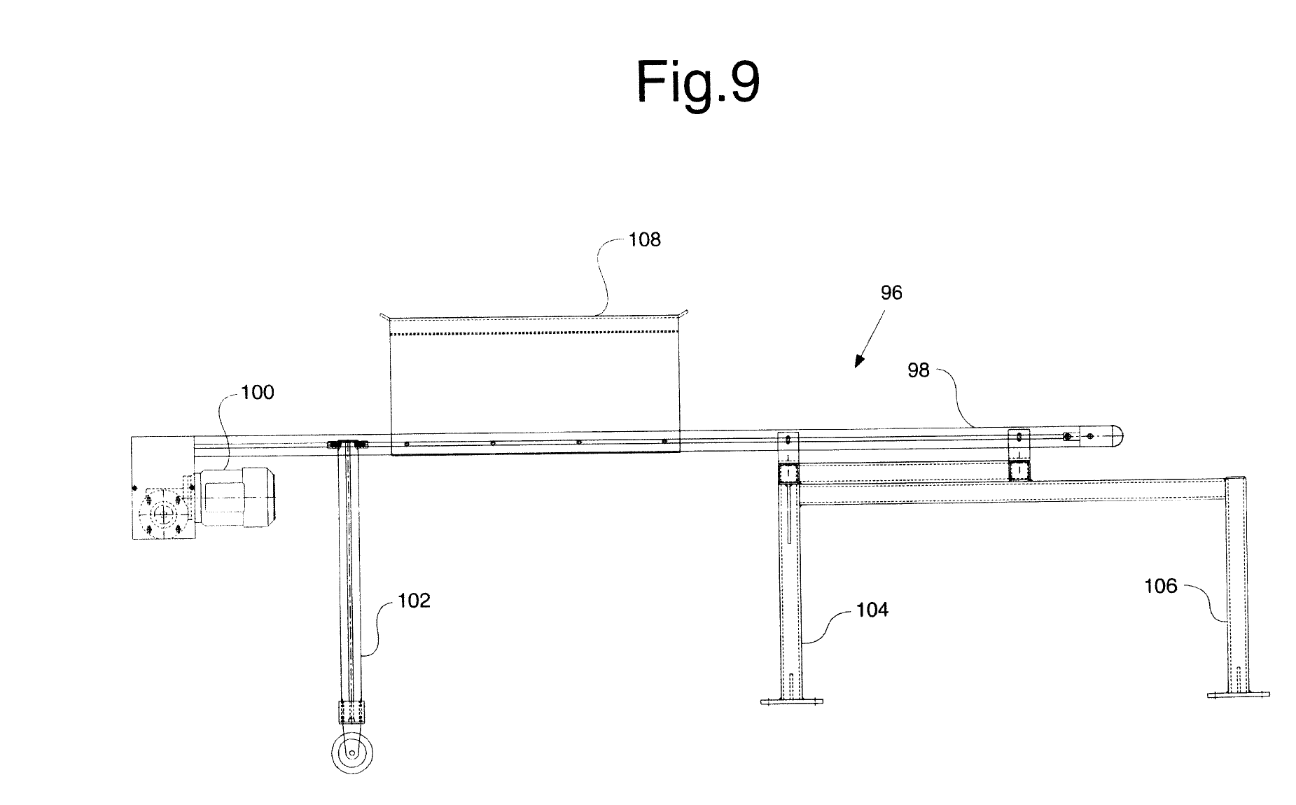

FIG. 9 illustrates one embodiment of a typical conveyance system 96 constructed in accordance with the teachings of the present invention. The conveyance system 96 includes a conveyor mechanism 98, drive means 100 for moving the conveyor 98 in an appropriate direction, and an appropriate mounting structure such as the leg brace members 102, 104 and 106 for positioning, locating and mounting the conveyance system 96 adjacent trim press 48. In the particular embodiment disclosed in FIGS. 2 and 4, conveyance system 96 is positioned and located beneath support structure 50 such that once the pick and place tool 52 is removed from trim press 48, the tool 52 can be maneuvered and positioned over conveyance system 96 and, more particularly, over conveyor 98 such that all of the thermoformed articles or parts held by tool 52 can be released onto conveyance system 96. Once the thermoformed articles or parts are released onto conveyance system 96, the pick and place tool 52 will move back to its starting position outside of trim press 48 and repeat the cycle once the trim press again opens. Conveyance system 96 may likewise include a tunnel or hood 108 for protecting the thermoformed articles or parts during transportation away from trim press 48 to an operator pack-off area or some other location. In this regard, conveyance system 96 can likewise be programmed to allow a predetermined number of finished articles or parts to be stacked one on top of the other before transportation to a different location, or the conveyance system 96 can be programmed to transport the finished articles or parts after each offload accomplished by pick and place tool 52. Leg brace members 102, 104 and 106 may likewise be adjustable so as to facilitate the positioning of conveyance system 96 at the proper height underneath support structure 50.

To accomplish the pick and place process, it is necessary to maintain proper synchronization with the trim press cycle. This synchronization is typically accomplished and controlled through one or more process controllers associated with the thermoforming system. For example, in one embodiment of the present invention, after the trim press 48 opens and the lower trim press tool 56 retracts, the pick and place tool 52 moves horizontally into the trim press, settling into a position wherein the array of part acquisition devices, such as vacuum cups 92, are positioned and located in alignment with the array of severed finished parts. A short vertical movement is then cued to initiate engagement of the various vacuum cups 92 or other part acquisition devices with the severed thermoformed parts thereby allowing the pick and place tool 52 to capture and hold the articles or parts. The movement of the pick and place tool 52 is then reversed and retracted from the trim press 48 as the sheet or web of material is advanced in the chain rails 72 one index. Thereafter, as trim press 48 closes for severing the next batch or lot of thermoformed parts, the pick and place tool 52 strokes vertically to the conveyance system 96 where it releases the finished thermoformed parts and moves back to its starting position outside of the trim press 48 for repeating the cycle once the trim press opens. The vertical movement of the pick and place tool 52 to the conveyance system 96 becomes incrementally smaller each cycle so as to create a plurality of stacks of finished parts, until a predetermined stack height is reached and the conveyance system 96 clears the stacking surface.

The pick and place tool 52 is also designed such that the plurality of vacuum means 90 can be operated as separate multiple vacuum zones through the use of a plurality of valves which control air and vacuum to the various vacuum means 90. Multiple vacuum zones enable the pick and place tool 52 to release only a portion of the severed articles being held by the tool while other severed articles remain captured and held by the tool until further released. This arrangement facilitates stacking of the severed articles onto a conveyance system such as conveyance system 96 wherein only a portion of the severed articles can be released from the pick and place tool 52 onto the conveyance system 96, the tool 52 can then be repositioned relative to the released severed articles, and another portion of the severed articles held by tool 52 can be released on top of the previously released articles. This facilitates stacking of the finished articles upon removal from trim press 48. Multiple vacuum zones associated with the pick and place tool 52 allow what is known in the industry as “A-B” stacking.

Although one embodiment of the present robotic method and apparatus for removing finished thermoformed parts from a thermoforming trim press is disclosed and described herein, it is recognized and anticipated that other variations and modifications to the gantry mechanism 50, the pick and place tool mechanism 52, the carriage assembly 78, and the drive mechanisms associated therewith can be accomplished without departing from the spirit and scope of the present invention. It is also recognized and anticipated that the pick and place tool 52 and its accompanying support structure can be designed and configured such that the movement of the pick and place tool 52 may take place above the path 64 of the sheet or web of material. In this event, an up-stacking arrangement would be associated with the stacking of the finished thermoformed parts, and the carriage assembly 78 and the conveyance system 96 would be constructed to accommodate such a stacking arrangement. In this regard, the carriage assembly 78 would be constructed to allow the pick and place tool 52 to be maneuvered above the path 64 of the web of material and the conveyance system 96 would be appropriately positioned and located adjacent the support structure 50 at an appropriate height such that the tool 52 can be maneuvered over the conveyance system 96. In this situation, the pick and place tool 52 may include angular or rotational motion as well so that the tool 52 can be rotated to a position located adjacent the gantry or support structure 50 in order to deposit the finished parts onto a conveyance system located above or adjacent to the path 64 of the web of material. Still further, it is recognized that movement of all of the various components associated with the present invention including movement of the trim press platens 58 and 60 may be accomplished through any appropriate means including hydraulic, pneumatic and electrical, and any combinations thereof. Other modifications and applications are likewise envisioned.

As is evident from the foregoing description, certain aspects of the present invention are not limited by the particular details of the examples illustrated herein and it is therefore contemplated that other modifications and applications, or equivalents thereof, will occur to those skilled in the art. It is accordingly intended that the claims shall cover all such modifications and applications that do not depart from the spirit and scope of the present invention. Other aspects, objects and advantages of the present invention can be obtained from a study of the drawings, the disclosure and the appended claims.

1. An apparatus for removing at least one molded part from a trim press associated with a thermoforming process wherein the trim press is moveable between an open and closed position and is adapted to separate the at least one molded part from a web of material used in the thermoforming process, said apparatus comprising:
a cutting tool associated with the trim press, said cutting tool completely severing the at least one molded part from the web of material when the trim press is in its closed position;
a support structure positioned adjacent the trim press;
a pick and place mechanism mounted on said support structure;
a drive system for moving and manipulating the pick and place mechanism within the trim press when the trim press is in its open position;
holding means associated with the trim press for holding the at least one severed molded part within the trim press after severing occurs;
holding means associated with the pick and place mechanism for capturing and holding the at least one molded part when the trim press is in its open position and when the pick and place mechanism is maneuvered adjacent the at least one severed molded part; and
controller means for controlling movement of the pick and place mechanism into and out of the trim press, movement of the pick and place mechanism being synchronized with the opening and closing of the trim press such that the pick and place mechanism will engage and remove the at least one molded part from the trim press when the trim press is in its open position.

2. The apparatus defined in claim 1 wherein said pick and place mechanism includes a plurality of members each having at least one holding means for engaging and holding the at least one molded part.

3. The apparatus defined in claim 2 wherein said at least one holding means includes suction means.

4. The apparatus defined in claim 1 wherein said pick and place mechanism includes a plurality of members each having a plurality of holding means associated respectively therewith for engaging and holding a plurality of severed molded parts.

5. The apparatus defined in claim 4 wherein said holding means include suction means.

6. The apparatus defined in claim 4 wherein said plurality of holding means are segregated into multiple zones, each zone being independently operable.

7. The apparatus defined in claim 1 wherein the holding means associated with the trim press includes suction means.

8. The apparatus defined in claim 1 wherein the holding means associated with the trim press includes a plurality of orifices, said plurality of orifices being adapted for pulling a vacuum therethrough so as to maintain the at least one severed molded part in its respective position within the trim press from the time such at least one molded part is severed from the web of material through the opening of the trim press and capture of such at least one molded part by the holding means associated with the pick and place mechanism.

9. The apparatus defined in claim 1 wherein said support structure is fixedly mounted to the trim press.

10. The apparatus defined in claim 1 wherein the trim press includes an upper platen and a lower platen, said support structure being fixedly mounted to the trim press so as to maintain a constant relationship with at least the lower platen when the upper and lower platens are adjusted.

11. The apparatus defined in claim 1 wherein said support structure includes a pair of horizontal support members each having a drive system associated respectively therewith, at least one vertical support member having a drive system associated respectively therewith, and a substantially U-shaped carriage member coupled to the horizontal and vertical support members and their respective drive systems for horizontal and vertical movement.

12. The apparatus defined in claim 11 wherein said pick and place mechanism is coupled to said carriage member.

13. The apparatus defined in claim 11 wherein said carriage member includes a quick disconnect mechanism, said quick disconnect mechanism being adapted to engage and hold the pick and place mechanism.

14. The apparatus defined in claim 11 including a drive system coupled to said support structure for rotationally moving said pick and place mechanism relative to at least some of said support members.

15. The apparatus defined in claim 1 wherein said pick and place mechanism is maneuverable beneath the path of the web of material that continues through the trim press during the thermoforming process.

16. The apparatus in claim 13 wherein said quick disconnect mechanism includes means for providing a vacuum to the pick and place mechanism.

17. The apparatus defined in claim 1 wherein said controller means are programmable.

18. The apparatus defined in claim 1 including a conveyance system positioned adjacent the trim press for receiving the at least one severed molded part from the pick and place mechanism.

19. The apparatus defined in claim 18 wherein at least a portion of said conveyance system is positioned and located beneath said support structure.

20. The apparatus defined in claim 1 wherein said holding means associated with the pick and place mechanism includes multiple holding zones.

21. An apparatus for removing a plurality of thermoformed parts from a trim press associated with a thermoforming process wherein the trim press is moveable between an open and closed position and is adapted to separate the thermoformed parts from a sheet of material which is fed through the thermoforming process and through the trim press, said apparatus comprising:
a cutting tool associated with the trim press for completely severing the plurality of thermoformed parts formed within the sheet of material from the sheet of material when the trim press is in its closed position;
a support structure mounted adjacent the trim press;
a pick and place mechanism mounted to said support structure for movement into and out of the trim press;
a plurality of orifices associated with the trim press for pulling a vacuum therethrough, said orifices being positioned and located so as to hold the severed thermoformed parts once the parts are severed from the sheet of material;
vacuum means associated with the pick and place mechanism for engaging and holding the severed parts until removal from the trim press; and
programmable controller means for controlling movement of the pick and place mechanism into and out of the trim press, movement of the pick and place mechanism being synchronized with the opening and closing of the trim press such that the plurality of severed thermoformed parts can be removed therefrom.

22. The apparatus defined in claim 21 wherein said support structure includes a pair of horizontal support members and a pair of vertical support members, at least one of said horizontal support members and at least one of said vertical support members having a drive system associated respectively therewith, a carriage member coupled to at least some of said horizontal and vertical support members and to the respective drive systems for movement in both the horizontal and vertical direction, and a quick disconnect mechanism associated with said carriage member for engaging and holding said pick and place mechanism.

23. The apparatus defined in claim 21 wherein said pick and place mechanism includes a plurality of members each having a plurality of suction means associated therewith for engaging the severed parts, said suction means being positioned and located so as to coincide with the position and location of the severed parts within the trim press.

24. The apparatus defined in claim 23 wherein said plurality of suction means are segregated into multiple zones, each zone being independently operable.

25. The apparatus defined in claim 21 wherein said pick and place mechanism is positioned and located relative to said support structure so as to move beneath the path of the sheet of material that continues through the trim press during the thermoforming process.

26. The apparatus defined in claim 21 wherein the pick and place mechanism is positioned and located relative to said support structure so as to move above the path of the sheet of material that continues through the trim press during the thermoforming process.

27. The apparatus defined in claim 21 including a conveyance system positioned and located adjacent said support structure for receiving the severed parts from the pick and place mechanism when they are removed from the trim press.

28. The apparatus defined in claim 27 wherein the conveyance system is positioned and located such that at least a portion thereof passes beneath said support structure.

29. In a thermoforming system for forming a plurality of thermoformed articles from a sheet of thermoplastic material wherein said system includes a heater station for heating the sheet of material to its glass transition phase, a forming station where the sheet of material is formed into the specific shape of the articles being manufactured, and a trim press for removing the thermoformed articles from the sheet of material, the trim press being moveable between an open and closed position, the improvement comprising:
a plurality of knife blades associated with the trim press for completely severing the plurality of thermoformed articles from the sheet of material when the trim press is in its closed position;
a support structure positioned adjacent the trim press, said support structure including at least a pair of horizontal support members and at least a pair of vertical support members, a carriage member coupled to said horizontal and vertical support members, and a quick disconnect mechanism associated with said carriage member;
a pick and place mechanism mounted to said quick disconnect mechanism for movement into and out of the trim press;
a drive mechanism associated with some of said support members for moving said pick and place mechanism in at least a horizontal and vertical direction relative to said horizontal and vertical support members;
vacuum means associated with the trim press for holding the severed thermoformed articles within the trim press until removed therefrom;
vacuum means associated with said pick and place mechanism for capturing and holding the plurality of severed thermoformed articles when said pick and place mechanism is maneuvered into the trim press; and
controller means for controlling movement of the pick and place mechanism into and out of the trim press, movement of the pick and place mechanism being synchronized with the opening and closing of the trim press.

30. The improvement defined in claim 29 wherein said pick and place mechanism includes a plurality of members each having a plurality of vacuum means association therewith for engaging the plurality of severed thermoformed articles within the trim press.

31. The improvement defined in claim 29 wherein the pick and place mechanism moves beneath the path of the sheet of material that moves through the thermoforming system and through the trim press.

32. The improvement defined in claim 29 including a conveyance system positioned adjacent to the trim press and adjacent the support structure for receiving the plurality of severed thermoformed articles from the pick and place mechanism.

33. The improvement defined in claim 32 wherein at least a portion of said conveyance system passes underneath said support structure.

34. The improvement defined in claim 32 wherein said controller means controls the movement of the pick and place mechanism from the trim press to the conveyance system.

35. The improvement defined in claim 34 wherein said controller means controls the stacking of severed thermoformed articles onto the conveyance system.

36. A method for removing at least one molded part from a trim press associated with a thermoforming process wherein the trim press is moveable between an open and closed position and is adapted to separate the at least one molded part from a web of material used in the thermoforming process, said method comprising the following steps:
maneuvering the web of material and the at least one molded part formed therein into the trim press;
completely severing the at least one molded part from the web of material within the trim press;
holding the at least one severed molded part within the trim press after the part is completely severed from the web of material and the trim press is moved to its open position;
positioning a pick and place tool within the trim press for locating and acquiring the at least one thermoformed part;
capturing and holding the at least one thermoformed part with the pick and place tool;
removing the pick and place tool with the at least one thermoformed part engaged therewith from within the trim press;
positioning the pick and place tool with the at least one thermoformed part engaged therewith at a location outside of the trim press; and
releasing the at least one thermoformed part from the pick and place tool.

37. The method defined in claim 36 including the step of:
positioning a conveyance system adjacent the trim press;
maneuvering the pick and place tool with the at least one thermoformed part engaged therewith over the conveyance system;
releasing the at least one thermoformed part from the pick and place tool onto said conveyance system.

38. A method for removing at least one molded part from a trim press associated with a thermoforming process wherein the trim press is moveable between an open and closed position and is adapted to separate the at least one molded part from a web of material used in the thermoforming process, said method comprising the steps of:
providing a cutting tool associated with the trim press, said cutting tool completely severing the at least one molded part from the web of material when the trim press is in its closed position;
providing a support structure positioned adjacent the trim press;
providing a pick and place mechanism mounted on said support structure;
providing a drive system for moving and manipulating the pick and place mechanism within the trim press when the trim press is in its open position;
providing holding means associated with the trim press for holding the at least one severed molded part within the trim press after severing occurs;
providing holding means associated with the pick and place mechanism for capturing and holding the at least one molded part when the trim press is in its open position and when the pick and place mechanism is maneuvered adjacent the at least one severed molded part; and
providing controller means for controlling movement of the pick and place mechanism into and out of the trim press, movement of the pick and place mechanism being synchronized with the opening and closing of the trim press such that the pick and place mechanism will engage and remove the at least one molded part from the trim press when the trim press is in its open position.

39. The method defined in claim 38 including the step of:
providing a drive system coupled to said support structure for rotationally moving said pick and place mechanism relative to said support structure.

40. The method defined in claim 38 including the step of:
providing a conveyance system positioned adjacent the trim press for receiving the at least one severed part from the pick and place mechanism.

41. An method for removing a plurality of thermoformed parts from a trim press associated with a thermoforming process wherein the trim press is moveable between an open and closed position and is adapted to separate the thermoformed parts from a sheet of material which is fed through the thermoforming process and through the trim press, said method comprising the steps of:
providing a cutting tool associated with the trim press for completely severing the plurality of parts formed within the sheet of material from said sheet of material when the trim press is in its closed position;
providing a support structure mounted adjacent the trim press;
providing a pick and place mechanism mounted to said support structure for movement into and out of the trim press;
providing a plurality of orifices associated with the trim press for pulling a vacuum therethrough, said orifices being positioned and located so as to hold and acquire the severed thermoformed parts once the parts are severed from the sheet of material;
providing vacuum means associated with the pick and place mechanism for engaging and holding the severed parts for removal from the trim press; and
providing programmable controller means for controlling movement of the pick and place mechanism into and out of the trim press, movement of the pick and place mechanism being synchronized with the opening and closing of the trim press such that the plurality of severed thermoformed parts can be removed therefrom.

42. The method defined in claim 41 including the step of:
providing a conveyance system positioned and located adjacent said support structure for receiving the severed parts from the pick and place mechanism when they are removed from the trim press.

43. A method for removing a plurality of thermoformed articles from a trim press wherein said articles are formed from a sheet of thermoplastic material in a thermoforming system, the trim press being moveable between an open and closed position and being adapted for removing the thermoformed articles from the sheet of material, the method comprising the steps of:
providing a plurality of knife blades associated with the trim press for completely severing the plurality of thermoformed articles from the sheet of material when the trim press is in its closed position;
providing a support structure positioned adjacent the trim press, said support structure including at least a pair of horizontal support members and at least a pair of vertical support members, a carriage member coupled to said horizontal and vertical support members, and a quick disconnect mechanism associated with said carriage member;
providing a pick and place mechanism mounted to said quick disconnect mechanism for movement into and out of the trim press;
providing a drive mechanism associated with some of said support members for moving said pick and place mechanism in at least a horizontal and vertical direction relative to said horizontal and vertical support members;
providing vacuum means associated with the trim press for holding the severed thermoformed articles within the trim press until removed therefrom;
providing vacuum means associated with said pick and place mechanism for capturing and holding the plurality of severed thermoformed articles when said pick and place mechanism is maneuvered into the trim press; and
providing controller means for controlling movement of the pick and place mechanism into and out of the trim press, movement of the pick and place mechanism being synchronized with the opening and closing of the trim press.

44. The method defined in claim 43 including the step of:
providing a conveyance system adjacent said support structure for receiving the thermoformed articles from the pick and place mechanism when they are removed from the trim press.
